(19) United States
(12) Patent Application Publication
(10) Pub. No.: US 2020/0142489 A1
(43) Pub. Date: May 7, 2020

(54) INPUT DEVICE

(71) Applicant: NIDEC SANKYO CORPORATION, NAGANO (JP)

(72) Inventors: Goro NAKAMURA, Nagano (JP); Tadashi TAKEDA, Nagano (JP); Hiroshi KITAHARA, Nagano (JP)

(73) Assignee: NIDEC SANKYO CORPORATION, NAGANO (JP)

(21) Appl. No.: 16/627,340

(22) PCT Filed: Jun. 11, 2018
(86) PCT No.: PCT/JP2018/022167

§ 371 Date: Dec. 30, 2019

(30) Foreign Application Priority Data
Jun. 30, 2017 (JP) 2017-128678

(51) Int. Cl. G06F 3/01

(52) U.S. Cl. CPC G06F 3/016; G06F 3/0443

(57) ABSTRACT

An input device (100) has an input unit (1) provided with a touch panel (13), a frame (2) that surrounds the outer periphery of the input unit (1), and an actuator (3) that causes the input unit (1) to vibrate in the X direction. The input unit (1) and the frame (2) are configured such that even if the relative positions of the frame (2) and an outer periphery (5), which face each other in the in-plane direction of the touch panel (13), were to change due to the vibration of the input unit (1), this change tends not to be perceived as a visual change by a user, making it difficult to perceive the movement.

### TECHNICAL FIELD

The present invention relates to an input device in which an input surface of a touch panel is capable of being vibrated.

### BACKGROUND ART

Different from a mechanical type input device using a mechanical switch, while an input device using a touch panel has an advantage that an input screen is capable of being freely configured by software, an input operation feeling cannot be given to an operator. Therefore, a technique has been proposed that an input surface is vibrated in accordance with an input operation. In the touch panel device described in Patent Literature 1, vibration is transmitted from an actuator to a movable panel provided with a display device and a touch panel. The movable panel is disposed in a window part formed in a housing.

### CITATION LIST

### Patent Literature

[PTL 1] Japanese Patent Laid-Open No. 2007-34991

### DISCLOSURE OF THE INVENTION

### Problems to be Solved by the Invention

In the touch panel device described in Patent Literature 1, the movable panel (touch panel and display device) is vibrated in an integral manner, but the housing is not vibrated. Therefore, when the movable panel is vibrated, the vibration may be visually recognized. For example, a pattern such as a design is formed on a boundary between the housing and the movable panel, there is a possibility that the pattern serves as a mark and vibration is visually recognized.

In an input device which makes a user feel vibration with a tactile sense, when the vibration is recognized by a visual sense instead of a tactile sense, the visual sense disturbs the tactile sense and an intended tactile sense may not be recognized. For example, when vibration is recognized by a visual sense, the input device and its peripheral device main body are sensed to be shaken as a whole and thus, an intended tactile sense may be hardly felt from a fingertip of a user which touches the touch panel.

In view of the problem described above, an objective of the present invention is to provide an input device in which vibration is recognized with a tactile sense and a user is capable of recognizing the vibration appropriately.

### Means to Solve the Problems

To solve the above-mentioned problem, an input device in accordance with the present invention includes an input unit having a display device and a touch panel overlapped with the display device, a frame part which surrounds the input unit, and an actuator structured to vibrate the input unit in an in-plane direction of the touch panel with respect to the frame part. The input unit is provided with an outer peripheral part which faces the frame part in the in-plane direction and, when the input unit is vibrated in a vibration direction by the actuator, a feeling of movement obtained from a visual change based on change of relative position of the frame part and the outer peripheral part is smaller than a feeling of movement obtained through a tactile sense by touching the touch panel.

In the present invention, in order to vibrate an input unit having a display device and a touch panel to make a finger touching the touch panel feel the vibration, it is structured that a feeling of movement obtained through a tactile sense by touching the touch panel becomes larger than a feeling of movement obtained from a visual change based on change of relative position between a portion which is vibrated (outer peripheral part of the input unit) and a portion which is not vibrated (frame part). Therefore, a user recognizes the vibration mainly with a tactile sense and the vibration is hard to be recognized with a visual sense. Accordingly, a possibility that a user is disturbed by his/her visual sense and an intended tactile sense is hard to be felt can be reduced and thus, the user is capable of appropriately recognizing the vibration.

For example, it is preferable that the frame part is provided with a first frame part which is extended in the vibration direction, the first frame part is provided with a first pattern, and the first pattern does not change in the vibration direction and has no break in the vibration direction. In a portion (frame part) which is not vibrated, when a pattern having a change in the vibration direction or a pattern having a break in the vibration direction is formed in a portion (first frame part) extended in the vibration direction, the pattern easily serves as a mark for movement and thus, the movement is easily recognized visually. However, a pattern which does not change in the vibration direction and has no break does not serve as a mark for recognizing movement even when the input unit is vibrated and thus, the movement of the input unit is hard to be visually recognized. Therefore, a possibility that a user is disturbed by his/her visual sense and an intended tactile sense is hard to be felt can be reduced.

Further, it is preferable that the frame part is provided with a first frame part which is extended in the vibration direction, the first frame part is provided with a first pattern, the outer peripheral part is provided with a corner part in which a portion extended in the vibration direction and a portion extended in a direction intersecting the vibration direction are connected with each other, and the first pattern does not change in the vibration direction and has no break in the vibration direction at least at a position where the first frame part and the corner part face in the in-plane direction. According to this structure, at a position in the first frame part facing the corner part of the input unit which is vibrated, the first pattern is formed so as not to serve as a mark of movement. Therefore, the movement of the input unit is hard to be visually recognized and thus, a possibility that a user is disturbed by his/her visual sense and an intended tactile sense is hard to be felt is reduced.

In the present invention, it is preferable that at least an inner peripheral portion of the frame part is in a solid color. Further, it is preferable that the outer peripheral part is in a solid color. As described above, a portion near the boundary between a vibrated portion and a portion which is not vibrated (the inner peripheral portion of the frame part and the outer peripheral part) is in a solid color, there is no mark for movement and thus the movement is hard to be felt with a visual sense. Therefore, even when the input unit is vibrated, the movement is hard to be recognized and thus, a possibility that a user is disturbed by his/her visual sense and an intended tactile sense is hard to be felt is reduced.

In this case, it is preferable that both of at least an inner peripheral portion of the frame part and the outer peripheral part are in a solid color and are in a similar color to each other. Further, it is further preferable that both of at least an inner peripheral portion of the frame part and the outer peripheral part are in a solid color and are in the same color as each other. As described above, when a vibrated portion and a portion which is not vibrated are in a solid color and in the same color as each other or in a similar color to each other, they can be recognized as an integrated region. Therefore, even when the input unit is vibrated, the movement is hard to be visually recognized and thus, a possibility that an intended tactile sense of a user is hard to be felt due to disturbance of his/her visual sense is reduced.

In the present invention, it is preferable that a width of the inner peripheral portion in a direction facing the outer peripheral part is 1 cm or more. The present inventors have confirmed that, when a portion where there is no mark for movement is provided in a portion near the boundary between a vibrated portion and a portion which is not vibrated with a width of 1 cm or more, the movement is hard to be recognized and thus, the present inventors have reached to propose the above-mentioned structure. As a result, a possibility that an intended tactile sense of a user is hard to be felt due to disturbance of his/her visual sense can be reduced.

In the present invention, it is preferable that the display part is provided with a display surface on which the touch panel is overlapped, the display surface is provided with a display area and a non-display area provided on an outer peripheral side with respect to the display area, and the outer peripheral part includes the non-display area. According to this structure, a possibility is reduced that display contents of the display area serve as a mark and the movement is recognized visually.

In the present invention, it is preferable that the frame part and the touch panel are located on the same plane. According to this structure, an input surface of the input unit (surface of the touch panel) can be made flat without a step with respect to the peripheral frame part. Therefore, there is no step between a vibrating portion and a portion which is not vibrated and thus, the vibrating portion and the portion which is not vibrated can be structured so as to be observed as one body.

In the present invention, it may be structured that the actuator includes a movable body and a support body, a drive circuit structured to vibrate the movable body in the vibration direction with respect to the support body, and a connection body which connects the movable body with the support body, and the input unit is fixed to the support body.

### Effects of the Invention

According to the present invention, in order to vibrate the input unit having the display part and the touch panel to feel the vibration with a tactile sense, it is structured that a feeling of movement obtained through a tactile sense by touching the touch panel becomes larger than a feeling of movement obtained from a visual change between a vibrating portion (outer peripheral part of the input unit with respect to the frame part) and a portion which is not vibrated (frame part). Therefore, a user recognizes the vibration mainly by a tactile sense and the vibration is hard to be recognized by a visual sense. Accordingly, a possibility that a user is disturbed by his/her visual sense and an intended tactile sense is hard to be felt can be reduced and thus, the user is capable of appropriately recognizing the vibration.

### BRIEF DESCRIPTION OF THE DRAWINGS

FIG. 1 is an explanatory view showing a cross-sectional structure of an input device to which the present invention is applied.

FIG. 2 is an explanatory view showing a planar structure of the input device shown in FIG. 1.

FIG. 3 is a partial enlarged view showing planar structures of an outer peripheral part and a frame part in a first and a second embodiments.

FIG. 4 is a partial enlarged view showing a planar structure of an outer peripheral part and a frame part in a third embodiment.

FIG. 5 is a partial enlarged view showing a planar structure of an outer peripheral part and a frame part in a fourth embodiment.

### DESCRIPTION OF EMBODIMENTS

Embodiments of the present invention will be described below with reference to the accompanying drawings. In the following descriptions, three directions intersecting each other are defined as the “X” direction, the “Y” direction and the “Z” direction, and the “X1” is indicated on one side in the “X” direction, the “X2” is indicated on the other side in the “X” direction, the “Y1” is indicated on one side in the “Y” direction, the “Y2” is indicated on the other side in the “Y” direction, the “Z1” is indicated on one side in the “Z” direction, and the “Z2” is indicated on the other side in the “Z” direction. An input unit 1 includes a touch panel 13. The “X” direction and the “Y” direction are in-plane directions of an input surface 13a of the touch panel 13, and the “X” direction is the direction in which the input unit 1 is vibrated. Further, the “Z” direction is a normal direction with respect to the input surface 13a.

(Entire Structure)

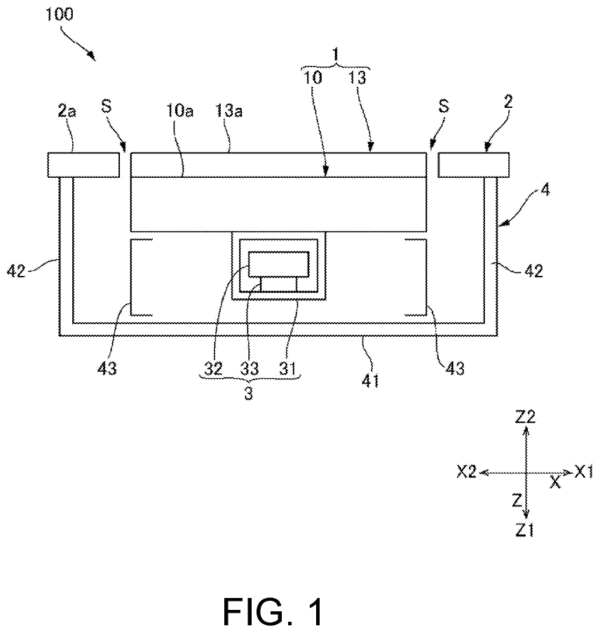

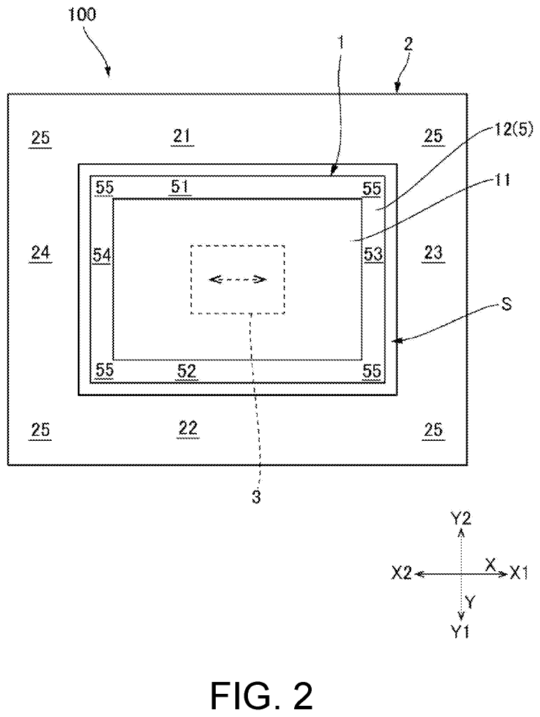

FIG. 1 is an explanatory view showing a cross-sectional structure of an input device 100 to which the present invention is applied. FIG. 2 is an explanatory view showing a planar structure of the input device 100 shown in FIG. 1. The input device 100 includes a touch panel type input unit 1, a frame part 2 which surrounds an outer peripheral side of the input unit 1, an actuator 3 which vibrates the input unit 1 with respect to the frame part 2, and a frame 4 which supports the input unit 1. The frame part 2 is fixed to or integrally formed with the frame 4. Alternatively, the frame part 2 may be separated from the frame 4 and they are respectively supported individually. The input device 100 is used as an operation panel for operating various apparatuses. For example, the input device 100 is attached to an inside of a vehicle as an operation panel for operating an apparatus mounted on the vehicle. In this case, the frame 4 is fixed to a component of the vehicle. Further, an edge portion of an opening formed in an interior panel of the vehicle can be used as the frame part 2.

The input unit 1 includes a display part 10 which is a direct view type display panel such as a liquid crystal display panel or an organic electroluminescence display panel, and a light transmissive touch panel 13 which is provided in an overlapped state on the other side “Z2” in the “Z” direction with respect to the display part 10. The display part 10 and the touch panel 13 are held by a holder member not shown. The touch panel 13 is, for example, an electrostatic capacity type touch panel and is disposed on a surface of the input unit 1.

A display surface 10a facing the other side “Z2” in the “Z” direction in the display part 10 is provided with a rectangular display area 11 for displaying various kinds of information, switches and the like, and a non-display area 12 in a rectangular frame shape which surrounds an outer peripheral side of the display area 11 (see FIG. 2). The input surface 13a of the touch panel 13 is provided at least in a range overlapped with the display area 11. A user is capable of inputting information by touching of a fingertip on a portion of the input surface 13a where switches are displayed by the display part 10. The input device 100 outputs an input result to a host control part (not shown).

As shown in FIG. 1, the frame 4 is provided with a bottom plate part 41 disposed on a back face side (one side “Z1” in the “Z” direction) of the input unit 1 and a side plate part 42 which is stood up from the bottom plate part 41 to the other side “Z2” in the “Z” direction. The input unit 1 is supported by the bottom plate part 41 through an elastic member 43. The elastic member 43 is, for example, a plate spring. Alternatively, a rubber block may be used as the elastic member 43. In this embodiment, the side plate part 42 surrounds an outer peripheral side of the input unit 1, and the frame part 2 is provided at a tip end on the other side “Z2” in the “Z” direction of the side plate part 42. In this case, as described above, the frame part 2 may be integrally formed with the side plate part 42, or the frame part 2 may be a separate member from the side plate part 42. Further, the frame part 2 may be supported by a support member different from the frame 4 without providing the side plate part 42.

(Actuator)

In this embodiment, a planar shape of the input unit 1 is rectangular. An actuator 3 is disposed between the input unit 1 and the bottom plate part 41, and the actuator 3 is fixed to the back face side (one side “Z1” in the “Z” direction) of the input unit 1. In this embodiment, the actuator 3 is fixed at one position at a center of the input unit 1. However, it may be structured that the actuators 3 are fixed at a plurality of positions and are synchronously driven. The actuator 3 generates vibration in the “X” direction. When the actuator 3 is driven, vibration of the actuator 3 is inputted into the input unit 1. As a result, the input unit 1 is vibrated in the “X” direction with respect to the frame 4 and the frame part 2.

As shown in FIG. 1, the actuator 3 includes a support body 31 and a movable body 32, a connection body 33 which connects the movable body 32 with the support body 31, and a drive circuit (not shown) for relatively moving the movable body 32 with respect to the support body 31. The movable body 32 is accommodated on an inner side of the support body 31, and the support body 31 is fixed on the back face side of the input unit 1. The connection body 33 is provided with elasticity or viscoelasticity. The drive circuit drives the movable body 32 in the “X” direction, and the movable body 32 is vibrated in the “X” direction. When the movable body 32 is vibrated in the “X” direction, the connection body 33 follows movement of the movable body 32 to be deformed in a shearing direction and appropriately restrains resonance when the movable body 32 is driven.

In the actuator 3 in this embodiment, the drive circuit (not shown) is a magnetic drive circuit which includes a coil held by one of the support body 31 and the movable body 32 and a magnet held by the other of the support body 31 and the movable body 32. The coil and the magnet face each other in the “Z” direction. When an alternating current is supplied to the coil, the magnet and the coil are relatively moved in the “X” direction and, as a result, the movable body 32 is vibrated in the “X” direction with respect to the support body 31. When the movable body 32 is vibrated in the “X” direction, a center of gravity of the actuator 3 is varied in the “X” direction and thus, the actuator 3 outputs vibration in the “X” direction. The actuator 3 outputs the vibration in the “X” direction to the input unit 1 through the support body 31 fixed to the input unit 1.

(Frame Part)

As shown in FIG. 2, the frame part 2 is a rectangular frame which is larger by one size than the input unit 1 and is provided with first frame parts 21 and 22, which are extended in the “X” direction (vibration direction) on both sides in the “Y” direction of the input unit 1, and second frame parts 23 and 24 which are extended in the “Y” direction (direction intersecting the vibration direction) on both sides in the “X” direction of the input unit 1. Further, the frame part 2 is provided with corner parts 25 where the first frame parts 21 and 22 extended in the “X” direction and the second frame parts 23 and 24 extended in the “Y” direction are connected with each other. In this case, the first frame parts 21 and 22 and the second frame parts 23 and 24 are not required to be formed by one body and may be formed in a separated manner. Further, the frame part 2 may be integrally structured with an apparatus main body on which the input device 100 is mounted. For example, in a case that an opening is formed in an interior panel of a vehicle and the input unit 1 is disposed in an inside of the opening to structure the input device 100, an opening edge portion of the interior panel structures the frame part 2.

As shown in FIG. 1, the frame part 2 and the input unit 1 structure a flat face as a whole. In other words, the frame part 2 is provided with a surface 2a directing the same direction (in other words, the other side “Z2” in the “Z” direction) as the input surface 13a of the touch panel 13, and the surface 2a is located on the same plane as the input surface 13a. A space “S” with a constant width is provided between an outer peripheral edge of the input unit 1 and an inner peripheral edge of the frame part 2. In this embodiment, the space “S” has the same width in all directions of both sides in the “X” direction and both sides in the “Y” direction with respect to the input unit 1. The actuator 3 vibrates the input unit 1 in the “X” direction within a range of the space “S”.

(Outer Peripheral Part)

The input unit 1 is provided with an outer peripheral part 5 which faces the frame part 2 in an in-plane direction (“X” direction and “Y” direction) of the input surface 13a. The outer peripheral part 5 is an outer peripheral portion of the input unit 1. In this embodiment, the non-display area 12 where information, switches and the like are not displayed is the outer peripheral part 5. In this case, the outer peripheral part 5 may include an end face of a holder (not shown) which holds the display part 10 and the touch panel 13.

The outer peripheral part 5 is provided with first outer peripheral parts 51 and 52 extended in the “X” direction (vibration direction) at end parts on both sides in the “Y” direction of the input unit 1, and second outer peripheral parts 53 and 54 extended in the “Y” direction (direction intersecting vibration direction) at end parts on both sides in the “X” direction of the input unit 1. The first outer peripheral parts 51 and 52 are extended along the first frame parts 21 and 22 and face the first frame parts 21 and 22 in the “Y” direction. Further, the second outer peripheral parts 53 and 54 are extended along the second frame parts 23 and 24 and face the second frame parts 23 and 24 in the “X” direction. Further, the outer peripheral part 5 is provided with corner parts 55 where the first outer peripheral parts 51 and 52 extended in the “X” direction and the second outer peripheral parts 53 and 54 extended in the “Y” direction are connected with each other.

(Planar Structure of Outer Peripheral Part and Frame Part)

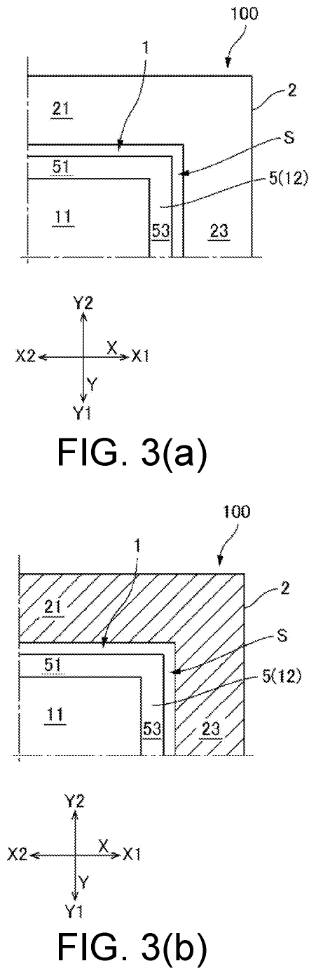

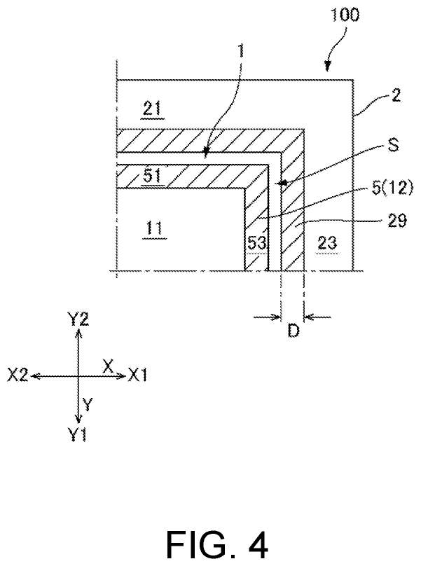

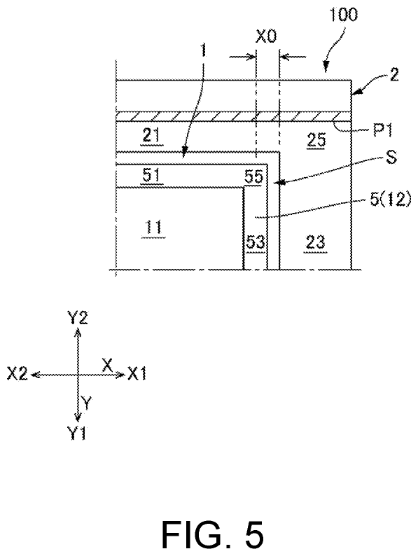

FIGS. 3 through 5 are partial enlarged views showing planar structures of the outer peripheral part 5 and the frame part 2. FIG. 3(a) shows a planar structure in a first embodiment, and FIG. 3(b) shows a planar structure in a second embodiment. Further, FIG. 4 shows a planar structure in a third embodiment and FIG. 5 shows a planar structure in a fourth embodiment. In the first through fourth embodiments, the input unit 1 and the frame part 2 are structured so that, even when relative position of the frame part 2 and the outer peripheral part 5 which are portions facing each other in an in-plane direction of the touch panel 13 is varied through vibration of the input unit 1, a user is hard to feel a change of the relative position as a visual change and hard to obtain a feeling of the movement from the visual change. Further, even when a feeling of the movement (vibration) is obtained from a visual change based on a change of relative position between the frame part 2 and the outer peripheral part 5, they are structured so that a feeling of the movement obtained from the visual change is smaller than a feeling of the movement obtained through a tactile sense obtained by touching the input surface 13a of the input unit 1. Therefore, it is structured that, when the input unit 1 is vibrated, the movement (vibration) is unable to be recognized visually or, even when the movement (vibration) is recognized visually, the movement (vibration) recognized visually does not disturb feeling of the movement (vibration) recognized by a tactile sense. Accordingly, a user is capable of feeling intended vibration with a tactile sense through a finger of the user touched on the input surface 13a.

As shown in FIG. 3(a), in a first embodiment, both of the outer peripheral part 5 and the frame part 2 are set to be in a solid color and the same color as each other. In this specification, the “solid color” means that a pattern of protrusions and recesses is not formed and that a pattern of lines or colors is not formed. Further, the pattern includes an arbitrary shape such as a design, a figure and a character. As described above, when no pattern is formed on the outer peripheral part 5 and the frame part 2, even when the frame part 2 is relatively moved with respect to the outer peripheral part 5, there is no mark for recognizing a change of the relative position as a visual change. Therefore, when the input unit 1 is vibrated, a visual change is hard to be felt and thus, feeling of the movement is hard to be obtained from a visual change. Accordingly, feeling of the movement recognized with a tactile sense can be prevented from being disturbed by a visual sense.

As shown in FIG. 3(b), both of the outer peripheral part 5 and the frame part 2 in a second embodiment are in solid colors, but their colors are different from each other. As described above, even though their colors are different, in a case that both of the outer peripheral part 5 and the frame part 2 are in solid colors, there is no mark for recognizing a change of relative position even when the frame part 2 is relatively moved in the “X” direction with respect to the outer peripheral part 5. Therefore, when the input unit 1 is vibrated, a visual change is hard to be felt and a feeling of the movement is hard to be obtained from the visual change. As a result, according to this structure, a feeling of the movement recognized with a tactile sense can be prevented from being disturbed by a visual sense. In this case, when colors of the outer peripheral part 5 and the frame part 2 are different from each other, it is preferable that they are similar colors rather than completely different colors.

As shown in FIG. 4, in a third embodiment, the outer peripheral part 5 is in a solid color, and the inner peripheral portion 29 of the frame part 2 is in a solid color. It is preferable that a color of the inner peripheral portion 29 of the frame part 2 is the same as that of the outer peripheral part 5, but they may be different from each other. In a case that the colors are different from each other, it is preferable that they are similar colors. A width “D” of the inner peripheral portion 29 of the frame part 2 is 1 cm or more. The present inventors have confirmed that, in a case that a portion of the frame part 2 adjacent to the outer peripheral part 5 is made to be in a solid color with a width of at least 1 cm, even when the frame part 2 is relatively moved in the “X” direction with respect to the outer peripheral part 5, the change of the relative position is hard to be recognized and the movement of the input unit 1 is hard to be visually recognized and, as a result, the present inventors have reached to propose the above-mentioned structure. Especially, the present inventors have confirmed that, in a case that the inner peripheral portion 29 is the same color as the outer peripheral part 5, even when a width of the inner peripheral portion 29 is about 1 cm, a visual change is hard to be felt when the input unit 1 is vibrated and a feeling of the movement is hard to be obtained from the visual change. Therefore, according to this structure, a feeling of movement recognized by a tactile sense can be prevented from being disturbed by a visual sense.

As shown in FIG. 5, in a fourth embodiment, the outer peripheral part 5 is in a solid color, but a pattern is formed in the frame part 2. For example, the first frame part 21 extended in the “X” direction (vibration direction) is formed with a first pattern “P1” in a straight line shape which is extended in the “X” direction (vibration direction). The first pattern “P1” may be a pattern which has no change in the “X” direction (vibration direction) and has no break in the “X” direction (vibration direction). For example, the first pattern “P1” may be a coloration pattern in which colors are coated in belt shapes which are extended in the “X” direction. Alternatively, a pattern which is formed in a belt shape so as to have protrusions and recesses extended in the “X” direction may be formed. Further, a pattern combined with these patterns may be used.

As described above, in a case that the first pattern “P1” which has no change in the vibration direction and has no break in the vibration direction is provided in a portion where the frame part 2 is extended in the vibration direction, even when the outer peripheral part 5 is relatively moved in the vibration direction with respect to the frame part 2, the first pattern “P1” is hard to serve as a mark for visually recognizing the movement of the input unit 1 with respect to the frame part 2. Therefore, even when the input unit 1 is vibrated in the “X” direction, a visual change is hard to be felt from the first pattern “P1” and a feeling of the movement is hard to be obtained from the visual change. As a result, according to this structure, a feeling of the movement recognized by a tactile sense can be prevented from being disturbed by a visual sense.

A portion where the first pattern “P1” is formed is a portion extended in the “X” direction of the frame part 2. For example, in addition to the first frame part 21, the first pattern “P1” may be formed in the first frame part 22. Further, it is desirable that the first pattern “P1” is extended to the corner parts 25 where the first frame parts 21 and 22 extended in the “X” direction and the second frame parts 23 and 24 extended in the “Y” direction are connected with each other. For example, in the fourth embodiment shown in FIG. 5, the first pattern “P1” is formed in the first frame part 21 and the corner part 25 of the frame part 2 and is extended to an end edge on one side “X1” in the “X” direction of the frame part 2 without a break. As described above, in a case that the first pattern “P1” is extended from the first frame part 21 to the corner part 25 without a break and without a change, a range where the first pattern “P1” is extended in the frame part 2 includes a position facing the corner part 55 in the “Y” direction where the first outer peripheral part 51 and the second outer peripheral part 53 of the input unit 1 are connected with each other. The “Y” direction is an in-plane direction of the touch panel 13 and is a direction intersecting the “X” direction which is the vibration direction.

In FIG. 5, a range shown by the reference sign “X0” shows a moving range where the corner part 55 of the input unit 1 is displaced in the “X” direction when the input unit 1 is vibrated. In the fourth embodiment, the range where the first pattern “P1” is extended is set in a range including the moving range “X0” of the corner part 55 of the input unit 1. For example, it is preferable that the first pattern “P1” is extended in a length of at least about 4 cm on both sides in the “X” direction with respect to the moving range “X0”.

As described above, in the fourth embodiment, the first pattern “P1” which does not change in the “X” direction and does not break in the “X” direction is provided in a range of the frame part 2 including a position facing the corner part 55 of the input unit 1 in the “Y” direction (in other words, a direction intersecting the vibration direction). The first pattern “P1” provided in the range is hard to serve as a mark for visually recognizing movement of the corner part 55 of the input unit 1 in the “X” direction and thus, even when the input unit 1 is vibrated in the “X” direction, the vibration is hard to be felt as a visual change from the first pattern “P1” and a feeling of the movement is hard to be obtained from the visual change.

A pattern which does not correspond to the first pattern “P1” in the present invention is a pattern which has a change in the vibration direction, or a pattern which has a break in the vibration direction. A pattern which has a change in the vibration direction is a pattern which is varied depending on a position in the vibration direction. For example, in a case that the vibration direction is the “X” direction, the pattern includes a wave-shaped pattern whose position in the “Y” direction is varied depending on a position in the “X” direction, a pattern whose color or design is varied depending on a position in the “X” direction, and the like. Further, a pattern which has a break in the vibration direction includes a pattern a part of which is cut in the “X” direction, and a pattern which is broken with a fixed pitch in the “X” direction. Such a pattern easily serves as a mark for recognizing a change of relative position in the vibration direction of the frame part 2 and the outer peripheral part 5 and thus, the vibration of the input unit 1 is easily recognized by a visual sense. Therefore, a feeling of the movement recognized by a tactile sense may be disturbed by a visual sense and thus intended vibration is hard to be felt.

### Principal Effects in this Embodiment

As described above, in the input device 100 in this embodiment, in order to vibrate the input unit 1 to make a finger touched on the panel 13 feel the vibration, it is structured that a feeling of movement obtained through a tactile sense by touching the touch panel 13 becomes larger than a feeling of movement obtained from a visual change based on change of relative position between a portion which is vibrated (outer peripheral part 5 of the input unit 1) and a portion which is not vibrated (frame part 2). Therefore, a user recognizes the vibration mainly by a tactile sense and the vibration is hard to be recognized by a visual sense. Accordingly, a possibility that a user is disturbed by a visual sense and an intended tactile sense is hard to be felt can be reduced and thus, the user is capable of appropriately recognizing vibration. Further, the planar structures of the first through the fifth embodiments shown in FIGS. 3 through 5 may be adopted as the structures capable of obtaining such a feeling.

In the embodiment described above, the input unit 1 is vibrated in the “X” direction. However, the present invention may be applied to an embodiment in which the input unit 1 is vibrated in the “Y” direction, and an embodiment in which the input unit 1 is vibrated in two directions of the “X” direction and the “Y” direction.

Further, in the embodiment described above, the surface (input surface 13a) of the input unit 1 and the surface 2a of the frame part 2 are located on the same plane to be a flat structure. However, a step may be existed between the input surface 13a and the surface 2a. For example, it may be structured that the frame part 2 is located on a front side (the other side “Z2” in the “Z” direction) with respect to the input unit 1. In this case, it may be structured that an outer circumferential edge of the input unit 1 is overlapped with the frame part 2 when viewed in the “Z” direction and that the outer circumferential edge of the input unit 1 is covered by the frame part 2.

### REFERENCE SIGNS LIST

1 . . . input unit, 2 . . . frame part, 2a . . . surface, 3 . . . actuator, 4 . . . frame, 5 . . . outer peripheral part, 10 . . . display part, 10a . . . display surface, 11 . . . display area, 12 . . . non-display area, 13 . . . touch panel, 13a . . . input surface, 21, 22 . . . first frame part, 23, 24 . . . second frame part, 25 . . . corner part, 29 . . . inner peripheral portion, 31 . . . support body, 32 . . . movable body, 33 . . . connection body, 41 . . . bottom plate part, 42 . . . side plate part, 43 . . . elastic member, 51, 52 . . . first outer peripheral part, 53, 54 . . . second outer peripheral part, 55 . . . corner part, 100 . . . input device, P1 . . . first pattern, X0 . . . moving range of corner part of input unit

1. An input device comprising:
an input unit comprising a display part and a touch panel overlapped with the display part;
a frame part which surrounds the input unit; and
an actuator structured to vibrate the input unit in an in-plane direction of the touch panel with respect to the frame part;
wherein the input unit comprises an outer peripheral part which faces the frame part in the in-plane direction; and
wherein when the input unit is vibrated in a vibration direction by the actuator, a feeling of movement obtained from a visual change based on change of relative position of the frame part and the outer peripheral part is smaller than a feeling of movement obtained through a tactile sense by touching the touch panel.

2. The input device according to claim 1, wherein
the frame part comprises a first frame part which is extended in the vibration direction,
the first frame part comprises a first pattern, and
the first pattern does not change in the vibration direction and has no break in the vibration direction.

3. The input device according to claim 1, wherein
the frame part comprises a first frame part which is extended in the vibration direction,
the first frame part comprises a first pattern,
the outer peripheral part comprises a corner part in which a portion extended in the vibration direction and a portion extended in a direction intersecting the vibration direction are connected with each other, and
the first pattern does not change in the vibration direction and has no break in the vibration direction at least at a position where the first frame part and the corner part face in the in-plane direction.

4. The input device according to claim 1, wherein at least an inner peripheral portion of the frame part is in a solid color.

5. The input device according to claim 1, wherein both of at least an inner peripheral portion of the frame part and the outer peripheral part are in a solid color and are in a similar color to each other.

6. The input device according to claim 1, wherein both of at least an inner peripheral portion of the frame part and the outer peripheral part are in a solid color and are in a same color as each other.

7. The input device according to claim 4, wherein a width of the inner peripheral portion in a direction facing the outer peripheral part is 1 cm or more.

8. The input device according to claim 1, wherein the outer peripheral part is in a solid color.

9. The input device according to claim 1, wherein
the display part comprises a display surface on which the touch panel is overlapped,
the display surface comprises a display area and a non-display area provided on an outer peripheral side with respect to the display area, and
the outer peripheral part includes the non-display area.

10. The input device according to claim 1, wherein the frame part and the touch panel are located on a same plane.

11. The input device according to claim 1, wherein
the actuator comprises:
a movable body and a support body;
a drive circuit structured to vibrate the movable body in the vibration direction with respect to the support body; and
a connection body which connects the movable body with the support body, and
vibration is outputted to the input unit through the support body.
